(19) United States
(12) Patent Application Publication
(10) Pub. No.: US 2004/0035457 A1
(43) Pub. Date: Feb. 26, 2004

(54) Miniature thermal device

(76) Inventor: Abraham Kribus, Rehovot (IL)

Correspondence Address: BROWDY AND NEIMARK, P.L.L.C., 624 NINTH STREET, NW, SUITE 300, WASHINGTON, DC, 20001-5303, US

(21) Appl. No.: 10/333,819

(22) PCT Filed: Jul. 5, 2001
(86) PCT No.: PCT/IL01/00617

(30) Foreign Application Priority Data
Jul. 27, 2000 (IL) 137562

(51) Int. Cl. H01L 35/30

(52) U.S. Cl. 136/205

(57) ABSTRACT

A miniature thermal device (4) comprising a plurality of thermal elements (4) each having a thermal energy absorber (15) and a micro-heat converter (16) connected therewith so as to convert energy absorbed by the absorber (15) into another utilizable form of energy. The thermal elements (4) are assembled so that their absorbers (15) form there between a receiver cavity capable of receiving heat from an external heat source.

### FIELD OF THE INVENTION

The invention relates to miniature thermal systems for producing power from thermal energy such as the energy of solar radiation, combustion, industrial waste heat and the like.

### BACKGROUND OF THE INVETION

At present, thermal systems producing power are considered to be mostly effective if they are of large scale. Thus, electric power generated by gas turbines and internal combustion engines, is conventionally produced centrally on megascale and is then distributed to individual users. In large-scale solar plants that have until now been suggested by researchers, power generation is also centralized at a single central engine to which solar energy that has been collected over a large area, is channeled. However, since the investment and the risk associated with the transition from R&D to commercial applications of such large solar plants are very high, attempts that have been made to commercialize solar energy technologies, have not been successful so far.

Recent developments of microelectrical and mechanical systems (MEMS) and, particularly, of power MEMS such as micro-scale heat engines with built-in electrical generators, may change the situation since they appear to be capable to producing power of 10 to 100 watts in micro-size (in the order of 1 cm or less) packages. Such power densities are equivalent to those in the best large-scale machines known today. The developments of different power MEMS are reported, for example, in Mejumdar et al, Micro power devices, Microscale Thermophysical Ergineering 2:67-69, 1998; Epstein et al, Micro heat engines, gas turbines, and rocket engines—the MIT microengine project, 28 ALAA Fluid Dynamics conference, 1997; Nakajima et al, Study on microengines: miniaturizing Stirling engines for actuators, Sensors and Actuators 20: 75-82; and U.S. Pat. No. 5,457,956 to Bowman et al.

However, the above publications do not refer to the provision of efficient simultaneous supply of heat to a plurality of MEMSs, which is particularly important for large-scale systems for both conventional and solar applications.

It is the object of the present invention to provide a miniature thermal device in which thermal energy may be forwarded simultaneously to a plurality of micro-elements adapted to convert this energy into electrical or other utilizable forms of energy.

### SUMMARY OF THE INVENTION

In accordance with the present invention, there is provided a miniature thermal device comprising a plurality of thermal elements each having a thermal energy absorber and a micro-heat converter connected therewith so as to convert energy absorbed by the absorber into another utilizable form of energy, the elements being assembled so that their absorbers form therebetween a receiver cavity capable of receiving heat from an external heat source.

The thermal device according to the present invention constitutes an integral receiver-converter assembly, where the heat supplied to the receiver cavity is simultaneously utilized by all thermal elements, i.e. absorbed by their absorbers and converted by their micro-converters.

Preferably, the micro-heat converters of the thermal device according to the present invention, are micro-generators of electrical energy. They may also be of the kind that utilizes thermal energy for performing chemical reactions.

The external source of heat to be received in the receiver cavity may be incident solar radiation, or rather any suitable artificial source of heat such as, e.g. combustion heat or industrial waste heat. In the case of solar radiation, one wall of the thermal element is formed with an aperture for admitting this radiation into the receiver cavity. In this case, the thermal device may be associated with its own solar radiation concentration optics of any conventional type suitable for downscaling. For example, the concentrator may be a parabolic dish. If an artificial heat source is used, the thermal device is provided with means for introducing heat from this source into the receiver chamber. For example, the receiver cavity may be designed to serve as a combustion chamber and heat exchanger that supplies heat to micro-converters of all thermal elements.

The thermal device of the present invention may have a hybrid design with the receiver cavity having an aperture for admitting therein solar radiation and with the absorbers being each connected to an alternative artificial heat source for supplying heat therefrom, to enable the operation of the device to continue even when sunlight is not available.

All the components of the thermal device of the present invention enable its adaptation for mass production Thus, recent developments of micro-machine technology allow the fabrication, in mass-production quantities, of miniature self-contained micro-generators of the kind suitable for the thermal device, according to the present invention. For solar applications, for example, parabolic dishes are very simple to manufacture and they can be easily adapted for mass production (as this is done for automotive headlight reflectors). Therefore, commercial scale solar energy plants may be built of thousands and even millions of thermal devices according to the present invention. Such solar energy plants may have very high reliability, scalability to any desired size with no effect on their performance, low cost through mass production even for relatively low power levels and low investment and risk in development and demonstration technology.

### BRIEF DESCRIPTION OF THE DRAWINGS

For better understanding, the present invention will now be described, by way of examples only, with reference to the following accompanying drawings of which:

FIG. 1 is a schematic illustration of a thermal device according to the present invention, in a central cross-sectional view taken through the thermal device's aperture;

FIGS. 2A and 2B are schematic cross-sectional illustrations of the internal arrangement of two alternative embodiments of a thermal element employed in the thermal device of FIG. 1 ; and

FIG. 3 is a schematic illustration of a solar energy system according to the present invention, comprising the thermal device of FIG. 1.

### DETAILED DESCRIPTION OF SPECIFIC EMBODIMENTS

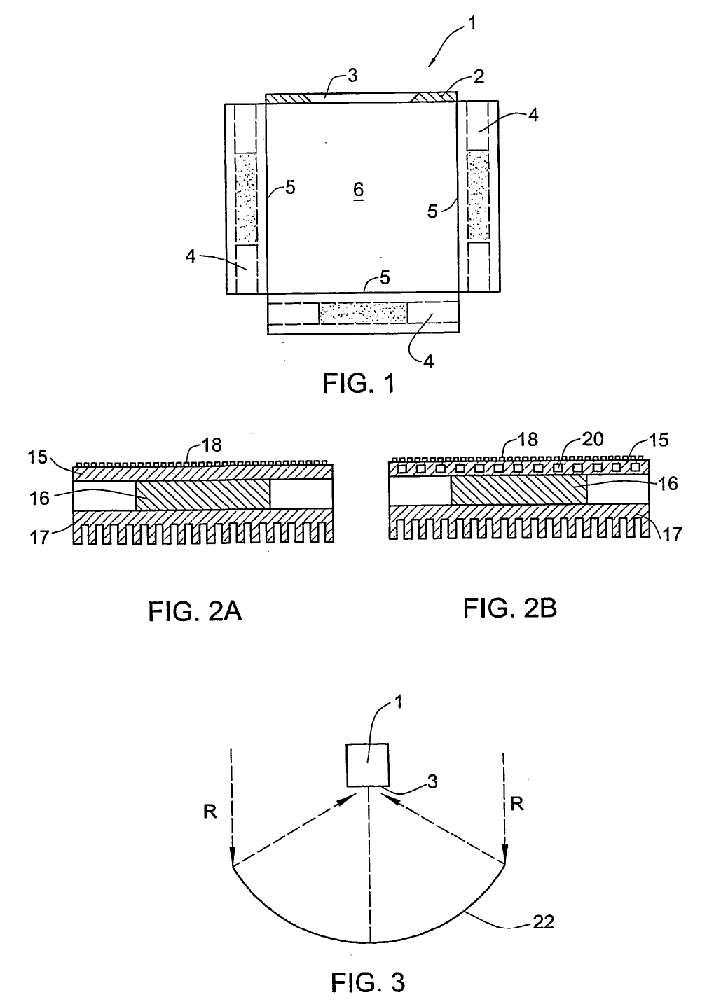

FIG. 1 shows schematically an example of a miniature thermal device according to the present invention, intended for use in solar thermal electricity generation. This thermal device will be hereinafter referred to as Solar Thermal Integral Micro-Generation (STIMG) device.

The STIMG device 1 shown in FIG. 1 has a cubic form with a front wall 2 formed with an aperture 3, side and rear walls 5 in the form of thermal elements 4, and a receiver cavity 6 defined between the walls 2 and 5, for admitting solar radiation incident through the aperture 3. To minimize convection and emission losses through the aperture 3, it is preferably in the form of a transparent window, and the receiver cavity 6 may be filled with a relatively inert gas such as nitrogen for preventing oxidation. The device 1 does not necessarily have to be cubic but rather may be of any other polygonal shape. The thermal elements are preferably flat but, if necessary, they may have another appropriate shape.

The thermal elements 4 may be held together by any suitable mechanical means so that they can be easily dissembled and replaced. For example, the thermal elements 4 may each be mounted in an appropriate chassis of a common frame or rather may be attached to each other by suitable coupling means.

As shown in FIGS. 2A and 2B, each thermal element 4 comprises an absorber 15 facing the receiver cavity 6, a micro-generator 16 capable of converting heat absorbed by the absorber 15 into electric energy and a heat rejector 17 for dissipating low temperature heat from the micro-generator into the environment.

The absorber's surface 18 facing the receiver cavity 6 is shown generally planar, in FIGS. 2A and 2B, but it may have another design, e.g. to suit a desired design of the receiver cavity. The absorption capability of the absorber 15, in particular of its surface 18, may be increased by surface roughness or by the extension of the area of the surface, e.g. by providing grooves thereon. The heat rejector 17 has also extended surfaces for facilitating heat rejection.

The micro-generator 16 may generally be of any suitable type for which downscaling is feasible, and depending on its design, it should be provided with appropriate electrical and fluid connections (not shown) necessary for its operation.

For example, the micro-generator 16 is a Stirling type micro-engine, such as described by Bowman et al in U.S. Pat. No. 5,457,956 incorporated herein by reference. In this case, the absorber 15 and the heat rejector 17 will be in direct contact with the micro-generator 16 for the high-temperature heat from the absorber 15 to enter the nicro-generator, and the low temperature heat to leave it, by conduction. Thus, the absorber 15 and the heat rejector 17 constitute tile micro-generator's hot and cold heat sinks, respectively. Thereby, conduction losses in the STIMG device 1 may be essentially minimized since its hot heat sink does hot have direct connection to the environment. Consequently, in the device having such a design, no insulation of the receiver cavity is needed.

Furthermore, the micro-generator 16 may be a Brayon type micro-engine, of the kind that is currently under development at MIT (whose description in Epstein et al, Micro heat engines, gas turbines, and rocket engines—the MIT microengine project, 28 AIAA Fluid Dynanics conference, 1997, is incorporated herein by reference), the combustion there is replaced by heating a working gas by solar radiation after the gas has been compressed and before it entered the micro-engine's turbine. For this purpose, the absorber 15 should be formed with an intermediate heat exchanger designed so that, in operation, its absorber side is heated by the solar radiation admitted in the receiver cavity 6, and the heat is conveyed to the working gas by conduction and convection. As shown in FIG. 2B, the heat exchanger may be in the form of channels 20 extending inside the absorber 15.

The micro-generator 16 may also be a direct converter such as thermoelectric or thermo-photovoltaic micro-converters described, respectively, in DiSalvo, F. J., Thermoelectric cooling and power generation, Science 285:703-706, 1999; and Dresselhous et al, The promise of low-dimensional thermoelectric materials, Microscale Thermophysical Engineering 3: 89-100, 1999, and in Schubnell et al, Design of a thermophotovoltaic residential heating system, Solar Energy Materials and Solar Cells 52: 1-9, 1998. The arrangement of such micro-converters in the STIMG device 1 will be similar to that described above for a Stirling type micro-engine.

As schematically shown in FIG. 1, the absorber 15, the micro-generator 16 and the heat rejector 17 may be arranged in a rectangular flat box with the absorber constituting an internal long side of the box facing the receiver cavity 6 and the heat rejector constituting an external side of the box. Clearly, such a box needs to be formed with appropriate inlets and outlets for electrical connections required for the micro-generator and fluid connections, if necessary. Also, electrical outputs from all micro-generators are to be collected to a single conductor.

FIG. 3 shows the STIMG device 1 according to the present invention, provided with a concentration optics 22 in the form of a parabolic mini-dish for concentrating incident solar radiation R and directing it to the aperture 3 of the thermal device 1. The concentration optics may comprise, in addition to the mini-dish, secondary concentrating, reflecting and/or guiding elements (not shown).

The STIMG device 1 according to the present invention may further be provided with an additional external heat source (not shown) for enabling its continued operation when the sunlight is not available. The external source may be a conventional fuel or a renewable fuel such as biogas derived from organic waste, and the STIMG device has to be provided with a combustion arrangement for burning the fuel. Micro-generators of the Brayton type have this arrangement anyhow. Stirling micro-generators and direct converters need this arrangement in the form of a small combustion unit either externally attached to the STIMG device or internally integrated within the micro-generator, in combination with a heat exchanger via which hot air from the combustion unit may heat the absorber 15. The absorber 15 of FIG. 2, having the channels 20, may be used for this purpose.

The following are examples of operating conditions for use of Stirling and Brayton STIMG devices for the conversion with maximal efficiency of solar energy into electricity, according to the present invention, that have been calculated under certain normally made assumptions:

| Cycle | Stirling | Brayton |
|---|---|---|
| Dish diameter (m) | 0.5 | 1.0 |
| Absorber size (mm) | 7 | 14 |
| Absorber temperature (C) | 1100 | 1200 |
| Efficiency | 43% | 9% |
| Power output (W) | 68 | 56 |

STIMG devices according to the present invention may be used as a basic unit for solar energy systems and solar energy plants in a great number of applications. In particular, for bulk electricity production, solar energy plants may be built of a plurality of solar energy systems each comprising a STIMG device and a concentration optics according to the present invention, all mounted on a common platform tracking the sun. Alternatively, a plurality of STIMG devices may have a common concentration optics capable of tracking the sun, and may be installed remote therefrom and be provided with guiding means such as optical fibers, for guiding thereto the concentrated solar radiation. The electrical output from all micro-generators on each platform is collected to a single conductor, which is connected to the outside line. Plants of any size can be constructed without changing the plant performance, since the basic unit is very small and can be reproduced as needed.

A solar energy system according to the present invention may further be used in stand-alone remote power applications. A single platform can generate up to a few kilowatts, depending on its overall size.

STIMG devices according to the present invention may also be used for portable power applications. The need for portable power is usually for very low power, and the main requirements are low weight, reliability and ease of use. This can be accomplished by a STIMG device on the scale of 10-100 watts. The concentration optics structure can, for example, be made of flexible thin sheet coated by a reflective layer and stretched on a space frame of thin members that provide the required parabolic curvature. The frame and sheet can be folded for storage and snapped open for deployment, similar to common structures for tents. A small fuel container can be used for hybrid operation when sunlight is not available.

STIMG devices and solar energy systems and solar plants using them, as well as non-solar thermal integral micro-generation devices, according to the present invention, may have features different from those described above and shown in the accompanying drawings, but rather may have alternative designs within the scope of the claims.

REFERENCE NUMERALS USED IN THE DRAWINGS:

| | |
|---|---|
| 1 | Solar Thermal Lintegral Micro-Generation (STIMG) device |
| 2 | Front wali of the device 1 |
| 3 | Aperture |
| 4 | Thermal element |
| 5 | Side and rear walls of the device 1 |
| 6 | Receiver cavity |
| 15 | Absorber |
| 16 | Micro-generator |
| 17 | Heat rejector |
| 18 | Absorber's surface facing the receiver cavity |
| 20 | Heat exchanger channels |
| 22 | Concentration optics |
| R | Incident solar radiation |

1. A miniature thermal device comprising a plurality of thermal elements each having a thermal energy absorber and a micro-heat converter connected therewith so as to convert energy absorbed by the absorber into another utilizable form of energy, the elements being assembled so that their absorbers form therebetween a receiver cavity capable of receiving heat from an external heat source.

2. A thermal device according to claim 1, wherein said micro-converter is a micro-generator of electrical energy.

3. A thermal device according to claim 1, wherein said absorber is associated with one surface of the micro-heat converter and an opposite surface of the micro-heat converter is associated with a heat rejector.

4. A thermal device according to claim 3, wherein said absorber and said heat rejector are in direct contact with said micro-heat converter.

5. A thermal device according to claim 4, wherein the absorber, the micro-heat converter and the heat rejector are integrally assembled in a substantially flat box-shape arrangement.

6. A thermal device according to claim 1, wherein said receiver cavity has a generally polygonal shape, each element forming one wall thereof.

7. A thermal device according to claim 6, wherein said receiver cavity is cubic.

8. A thermal device according to claim 1, wherein one wall of the thermal device is formed with an aperture for admitting therethrough solar radiation.

9. A thermal device according to claim 8, further comprising an external source of heat, for operating when sunlight is not available, said external source of heat being capable of supplying heat to said micro-heat converter either directly or via said absorber.

10. A solar energy system comprising at least one thermal device according to any one of claims 1 to 9, wherein said thermal device has an aperture for admitting solar radiation into the receiver cavity and is provided with a concentration optics for directing solar radiation into said aperture.

11. A solar energy system according to claim 10, comprising a plurality of said thermal devices that are mounted, together their concentration optics, on a common platform adapted to track the sun.

12. A solar energy system according to claim 10, comprising a plurality of said thermal devices disposed remote from said concentration optics, wherein said concentration optics is common for said devices and is capable of tracking the sun, the apertures of said devices being associated with guiding means for guiding thereto the concentrated radiation.

13. A solar energy plant comprising a plurality of solar energy systems according to claim 10, 11 or 12.
